(19) United States
(12) Patent Application Publication
(10) Pub. No.: US 2006/0104601 A1
(43) Pub. Date: May 18, 2006

(54) Method and apparatus for programming the storage of video information

(75) Inventors: Jitesh Arora, Thornhill (CA); Syed Hasnain, Thornhill (CA)

Correspondence Address: ATI TECHNOLOGIES, INC.;C/O VEDDER PRICE KAUFMAN & KAMMHOLZ, P.C., 222 N.LASALLE STREET, CHICAGO, IL, 60601, US

(73) Assignee: ATI TECHNOLOGIES, INC., MARKHAM (CA)

(21) Appl. No.: 10/989,051

(22) Filed: Nov. 15, 2004

(51) Int. Cl. H04N 5/76

(52) U.S. Cl. 386/46; 386/111

(57) ABSTRACT

A video information recorder receives video information including multiple scenes, and associates an automatic start marker with at least one of the scenes in response to receiving user-provided begin scene information. According to one embodiment, during playback the video information recorder stops recording in response to receiving the user provided begin scene information and resumes recording in response to receiving the user provided end scene information. According to an alternative embodiment, during playback the video information recorder skips, erases or overwrites the video information between the start and stop markers. The video information recorder also associates an automatic stop marker with at least one of the scenes without user intervention in response to receiving user-provided end scene information. The video information recorder may be a set top box, a digital or analog video recorder, a computer suitable for recording the video information, or any other device suitable for recording video information. The video information recorder includes a memory marker generator and memory. The video information recorder may be part of a host processor, a co-processor, such as a graphics co-processor, or any suitable device for marking the plurality of scenes as described above.

### FIELD OF THE INVENTION

The invention relates to the storage of video information, and more specifically to programming the storage of video information.

### BACKGROUND OF THE INVENTION

The introduction of digital and analog video recorders has made time-shifting of video information, such as audio and video information, easy for many home entertainment system users. Time-shifting of video information allows a user to manually “pause” the reception of the video information by directing the video information to a video recorder while maintaining an instantaneous image of the video information on a television A/V receiver or other video device. The video recorder continues to receive the video information, and “records” the video content onto the digital video recorder. When the user later resumes viewing, the video recorder continues to receive video information and to record the video information onto the video recorder, but the video information is presented from the point at which the user had paused the reception. In other words, the user plays video information that is delayed with respect to the video information being recorded.

According to one method, the digital video recorder generally has a “pause” button on a remote control to initiate a “pause” function. The remote control requires the user to press the pause button to initiate the pause function. This can be a problem for users who do not happen to be near the remote control when the event occurs. For example, while a user is enjoying home entertainment by watching a television program, listening to a broadcast over a stereo system, or watching streaming video over the Internet, the user can be distracted by simultaneously occurring events. For example, a telephone or doorbell may ring, a kitchen timer may signal that dinner is ready, or a washing machine may complete a wash cycle. Typically, when such events occur, the user manually pauses the storage of video information (initiating time-shifting) and resumes viewing later. Unfortunately, it is difficult to anticipate an interruption in broadcast programming, such as a commercial interruption in a television program. As a result, it is generally not feasible to program a video recorder to pause recording during a program interruption. Further, there is the potential the user might not un-pause the recorder to resume recording, and would miss recording of the program.

Like digital and analog video recorders, smart appliances have found their way into the homes and made life more convenient. Smart appliances, such as a processor-based oven or a washing machine that is coupled to the Internet or to a LAN (local area network) within a home, may be programmed to begin and end operation. Smart appliances can also initiate processes and can exchange information over the Internet or LAN. Like digital video recorders, it is difficult to anticipate an interruption in broadcast programming, such as a commercial interruption in a television program.

According to another method, a video recorder is programmed to record an entire scheduled program, including all program interruptions. A review of the entire program is performed and program interruptions are marked, based on an estimate of the start of the program interruption, and the anticipated length of the program interruption. Once the recording is marked, during playback, scenes that were previously marked are skipped. Typically, such methods incorrectly identify the start of a program, resulting in the failure to record a portion of the desired program. Further, these methods may miss the start and end of a program interruption resulting in playing a program interruption and possibly skipping over the desired program. As a result, the method requires recording of both the desired program and all the program interruptions, as well. Therefore, storage space is wasted storing the program interruptions. As a result, sufficient storage space is required in order to store all of the programs, including the program interruptions.

### BRIEF DESCRIPTION OF THE DRAWINGS

The present invention is illustrated by way of example and not limitation of the accompanying figures, in which like-referenced numerals indicate similar elements and in which:

FIG. 1 is a block diagram of a video information recorder in accordance with one exemplary embodiment of the invention;

FIG. 2 is a block diagram illustrating one example of a video information recorder/player in accordance with one exemplary embodiment of the invention;

FIG. 3 is a flow chart illustrating an example of a method for storing video information according to one exemplary embodiment of the invention;

FIG. 4 is a block diagram illustrating another example of a video data/recorder/player in accordance with another exemplary embodiment of the invention;

FIG. 5 is a flow chart illustrating another example of a method for storing video information according to another exemplary embodiment of the invention; and

FIG. 6 is a block diagram of a scene timeline in accordance with one exemplary embodiment of the invention.

### DETAILED DESCRIPTION OF THE PREFERRED EMBODIMENTS

A video information recorder receives video information including multiple scenes, and associates an automatic start marker with at least one of the scenes in response to receiving user-provided begin scene information. According to one embodiment, during playback the video information recorder stops recording in response to receiving the user provided begin scene information and resumes recording in response to receiving the user provided end scene information. According to an alternative embodiment, during playback the video information recorder skips, erases or overwrites the video information between the start and stop markers. The video information recorder also associates an automatic stop marker with at least one of the scenes without user intervention in response to receiving user-provided end scene information. The video information recorder may be a set top box, a digital or analog video recorder, a computer suitable for recording the video information, or any other device suitable for recording video information. The video information recorder includes a memory marker generator and memory. The video information recorder may be part of a host processor, a co-processor, such as a graphics co-processor, or any suitable device for marking the plurality of scenes as described above.

A user may provide begin scene information in response to a user detecting at least one scene change from the plurality of scenes. The user may indicate the beginning of a scene change, such as, for example, the beginning of a commercial interrupting the desired program. The user enters user-provided end scene information, such as, for example, the anticipated duration of the program interruption, or, for example, the time of day or duration that the anticipated program interruption will end and the desired program will resume. Memory may resume storing one or more scenes subsequent to the automatic stop marker into memory. As a result, the video information recorder may be programmed to resume recording so that the scenes corresponding to the program interruption are not recorded, such that the video information recorder resumes recording when the desired program resumes.

Among other advantages, the video information recorder associates the automatic stop marker with at least one of the scenes or resumes recording, without employing user intervention. The automatic stop marker may assist in, for example while recording or during playback, deleting or skipping interruptions of a desired program recording. As a result, the video information recorder will automatically resume recording the program so that, if for example, the user becomes distracted during the program interruption and does not resume recording manually, the video information recorder will resume recording of the desired program. Further, the video information recorder may be programmed to prevent storage of program interruptions, thereby decreasing the amount of storage. For example, if the user is distracted, or if the user is not present during a program interruption, the video information recorder may be programmed to resume recording at a preset time without user intervention. According to one embodiment, the user-provided end scene information may be conveniently generated by the user pressing or cycling through pre-set duration increments, such as 30-second increments specifying the anticipated duration of the program interruption. As a result, recording will resume according to the user-provided end scene information. According to another embodiment, the video information recorder may continuously record the video information. In response to associating an automatic start marker and an automatic stop marker to the stored video information, the video information recorder may automatically search for and detect a start scene change and an end scene change to more accurately identify the program interruption. According to one embodiment, once the program interruption is identified, the video information recorder may erase the program interruption in order to reduce storage waste.

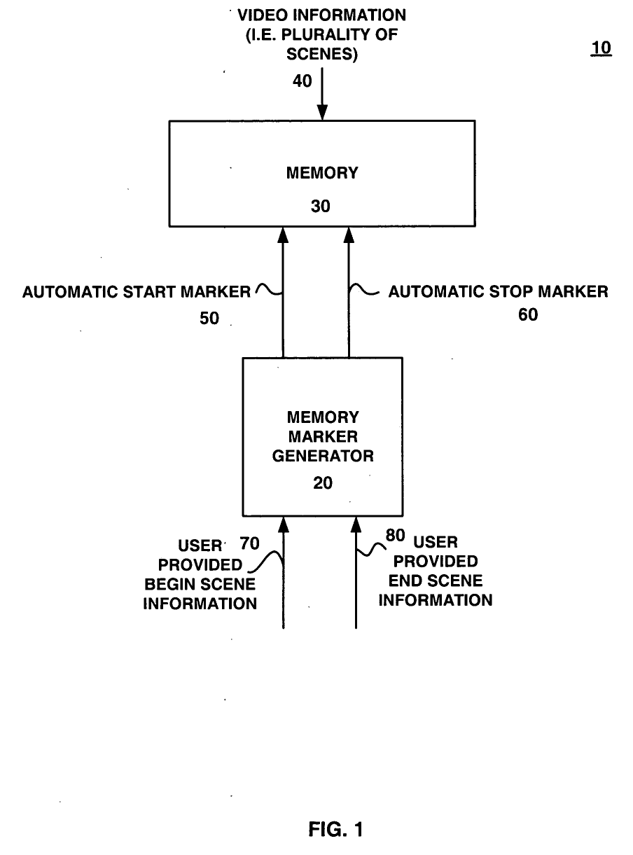

FIG. 1 is a block diagram of a video information recorder 10, including a memory marker generator 20 and memory 30. The memory marker generator 20 may be one or more suitably programmed processors, such as a microprocessor, a micro-controller or a digital signal processor (DSP), and therefore includes associated memory, such as memory 30, which contains instructions that, when executed cause the memory marker generator 20 to carry out the operations described herein. In addition, the memory marker generator 20, as used herein, may include discrete logic, state machines, or any other suitable combination of hardware, software, middleware, and/or firmware. The various elements of the video information recorder 10 are connected by a plurality of links. The links may be any suitable mechanisms for conveying electrical signals or data, as appropriate.

Memory 30 may store video information 40 such as, for example, analog or digital audio, text and video information from, for example, a cable, satellite or television broadcast, or for example, Internet video information. The memory 30 receives an automatic start marker 50 and an automatic stop marker 60. The memory 30 may be, for example, a disk drive, random access memory (RAM), read-only memory (ROM), optical memory or any suitable storage medium located locally or remotely, such as via a server or distributed memory if desired. Additionally, the memory 30 may be accessible by a wireless base station, switching system or any suitable network element via the Internet, a wide area network (WAN), a local area network (LAN), a wireless wide access network (WWAN), a wireless local area network (WLAN) such as but not limited to an IEEE 802.11 wireless network, a Bluetooth® network, an infrared communication network, a satellite communication network, or any suitable communication interface or network. According to one alternative embodiment, memory 30 may be part of system memory, graphics memory or any other suitable memory.

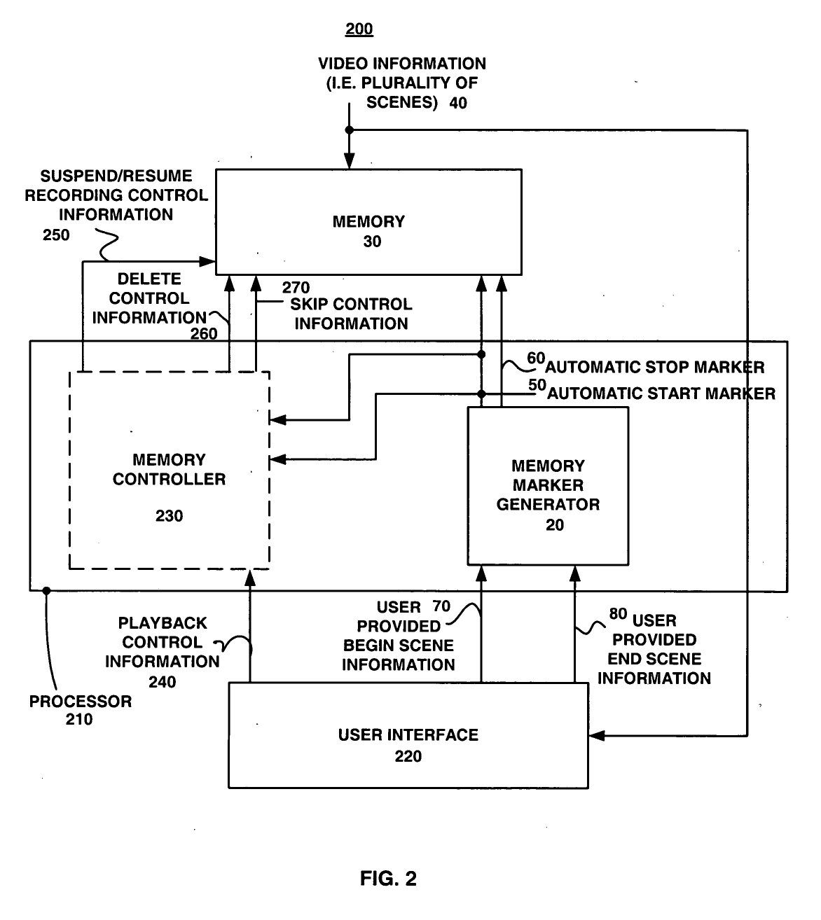

FIG. 2 is a block diagram of a video information recorder and player 200 according to one embodiment of the invention. The video information recorder and player 200 includes a processor 210 and a user interface 220. The processor 210 further includes a memory controller 230.

The processor 210 may be one or more suitably programmed processors, such as a microprocessor, a microcontroller or a digital signal processor (DSP), and therefore includes associated memory, such as memory 30, which contains instructions that, when executed, cause the processor 210 to carry out the operations described herein. In addition, the processor 210, as used herein, may include discreet logic, state machines or any other suitable combination of hardware, software, metalware and/or firmware.

According to one embodiment, the memory marker generator 20 may be part of a set top box, an analog or digital video recorder, a computer system or other suitable processor-based system. The computer system, or other processor-based system may include a central processing unit, video graphics circuitry, system memory and other suitable peripheral circuits. According to one embodiment, the central processing unit functions as a host processor while the video graphics circuitry (e.g., a graphics co-processor) functions as a loosely coupled co-processor. By way of example, the video graphics circuitry may be an integrated circuit on a single semi-conductor die, such as an application-specific integrated circuit (ASIC). Additionally, the video graphics circuitry may include memory, such as, but not limited to, dynamic random access memory (DRAM). This memory may reside on the same semiconductor die (ASIC) as the video graphics circuitry or it may be separate and connected through board level or package level traces. For example, the memory marker generator 20 may be part of the host processor or, alternatively, part of the video graphics circuitry. Accordingly, the above-described operation may be implemented in a software program, such as a driver program, executed by a host processor or any suitable processor.

The user interfaced 220 is coupled to the memory controller 230 and the memory marker generator 20 and memory 30. The user interface 220 provides user-provided begin scene information 70 and user-provided end scene information 80 to the memory marker generator 20. According to one embodiment, the user interface 220 provides playback control information 240 to the memory controller 230. The memory controller 230 provides suspend/resume recording information 250, delete information 260 and skip information 270 to memory 30.

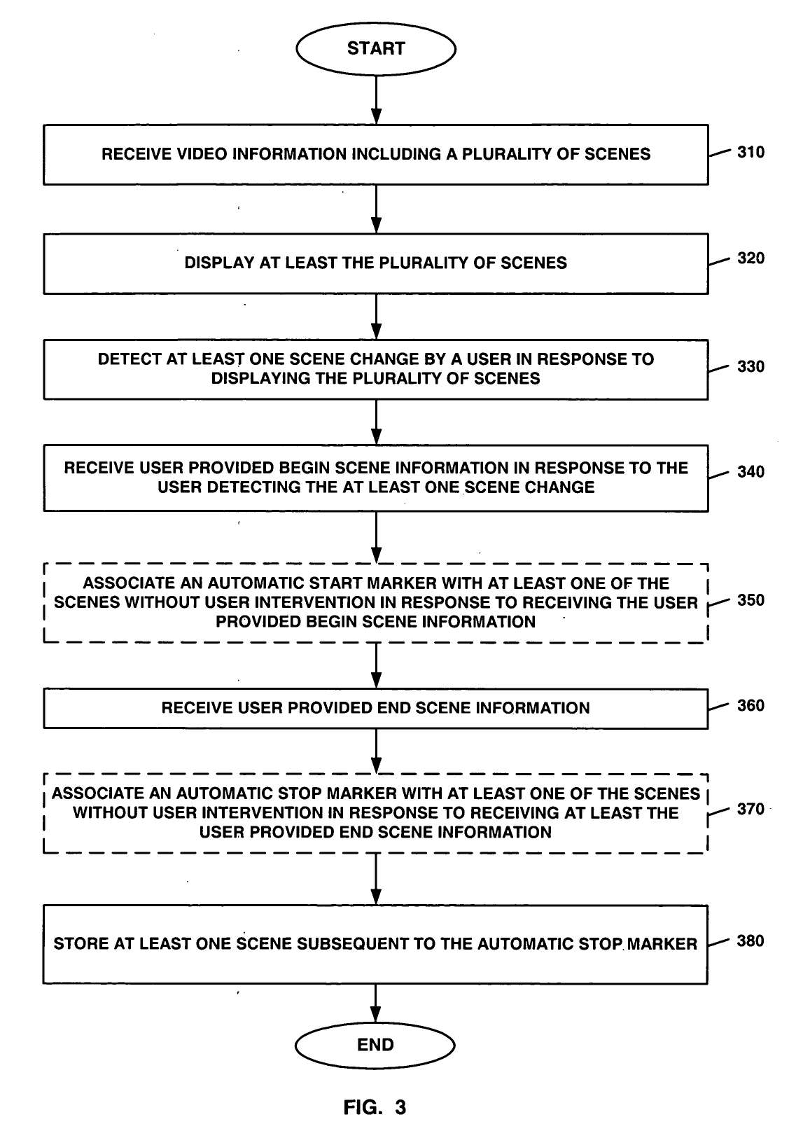

FIG. 3 illustrates a method for storing video information 40. The method may be carried out by the video information recorder 10 or the video information recorder and player 200; however, any other suitable structure may also be used. It will be recognized that the method, beginning with Step 310, will be described as a series of operations, but the operations may be performed in any suitable order and may be repeated in any suitable combination.

As shown in Step 310, the user interface 220 and the memory 30 receives video information 40, including a plurality of scenes. As previously stated, the video information 40 may include broadcast information such as cable, TV, satellite and Internet broadcasts. The video information 40 may, for example, include programs made up of themes, such as a television program and program interruptions that may include, for example, commercials, as they are commonly known in the art.

As shown in Step 320, the user interface 220 displays the plurality of scenes received as video information 40. For example, a user may be viewing of monitoring the video information 40 on a television or computer monitor.

As shown in Step 330, the user detects at least one scene change from the plurality of scenes received as video information 40. The user, for example, may detect a scene change from a desired program, such as a television program to a program interruption such as a commercial.

As shown in Step 340, the user causes the user interface 220 to provide user provided begin scene information 70 to the memory marker generator 20 in response to the user detecting the at least one scene change. For example, the user may push a button on a remote controller on the video information recorder 10 or video information recorder and player 200 that causes the user interface 220 to provide user provided begin scene information 70 to the memory marker generator 20.

As shown in optional Step 350, the memory marker generator 20 associates the automatic start marker 50 with at least one of the scenes without user intervention in response to receiving the user provided begin scene information 70. For example, as the memory 30 stores the video information 40, the memory 30 may associate a scene stored in memory 30 that was received and/or stored in memory 30 at approximately the same time when the user interface 220 generates the user provided begin scene information 70. According to one embodiment, the memory marker generator 20 includes a Microsoft Access database program, or any other suitable database program, to associate the at least one scene stored in the memory 30 with the automatic start marker 50. For example, the memory marker generator 20 may store within the database program a time stamp indicating the receipt of the user provided begin scene information 70. According to this embodiment, the automatic start marker 50 represents a time stamp indicating the time associated with the storage of a particular scene in memory 30. Alternatively, a log of recorded program history information may be generated and maintained in memory 30 or any suitable memory based on the received automatic start marker 50. The automatic start marker 50 and the automatic stop marker 60 may be used during playback to indicate the portions of the program interruption to for example skip or delete.

Alternatively, while recording, rather than associate the automatic start marker 50 and the automatic stop marker 60 with at least one of the scenes, the automatic start (interruption) marker 50 may simply indicate to the memory 30 to cease recorder during the program interruption. Similarly, the automatic stop (interruption) marker 60 may indicate to memory 30 to resume recording since the program interruption has ended. According to one embodiment, once the memory 30 ceases recording, an automatic end scene detection device or circuit automatically detects the end of the program interruption and causes resumption of recording.

As shown in Step 360, the user interface 220 receives user-provided end scene information 80 from the user. The user-provided end scene information 80 includes, for example, a time interval relative to the automatic stop marker 60. For example, the user may cycle between increments of time, such as 15 seconds or 30 seconds or one minute increments in order to indicate the expected duration of the program interruption. According to another embodiment, the user-provided end scene information 80 includes a time of day to indicate to the memory marker generator 20 the time of day when the expected program interruption will complete. The user interface 220 may then relay the user-provided end scene information 80 to the memory marker generator 20.

As shown in optional Step 370, the memory marker generator 20 associates the automatic stop marker 60 with at least one of the scenes in response to receiving the user-provided end scene information 80, without user intervention. Similarly, as discussed above with respect to the automatic start marker 50, the automatic stop marker 60 may represent a time stamp for association with at least one scene stored in memory 30 corresponding to the same time stamp. According to another embodiment, the automatic stop marker 60 represents data that is associated with the scene stored in memory 30. Alternatively, a log of recorded program history information may be generated and maintained in memory 30 or any suitable memory based on the received automatic start marker 50 and the automatic stop marker 60. The automatic start marker 50 and the automatic stop marker 60 may be associated with the received video information in memory based on for example, a time stamp, or any other suitable method.

As shown in Step 380, the memory controller 230 causes the memory 30 to store at least one scene subsequent to the automatic stop marker 60. For example, in response to the memory controller 230 receiving the automatic stop marker, the memory controller 230 provides suspense/resume recording information 250 to memory 30 for resuming recording in response to receiving the automatic stop marker 60. The optional memory controller 230 may during playback for example, review the automatic start marker 50 and the automatic stop marker 60 to skip, erase or overwrite the video information 40 as previously discussed. Alternatively, during recording, the memory marker generator 20 and/or the memory controller 230 may cause the memory 30 to cease recording during the detected program interruption and resume recording when the program interruption ends as also described above.

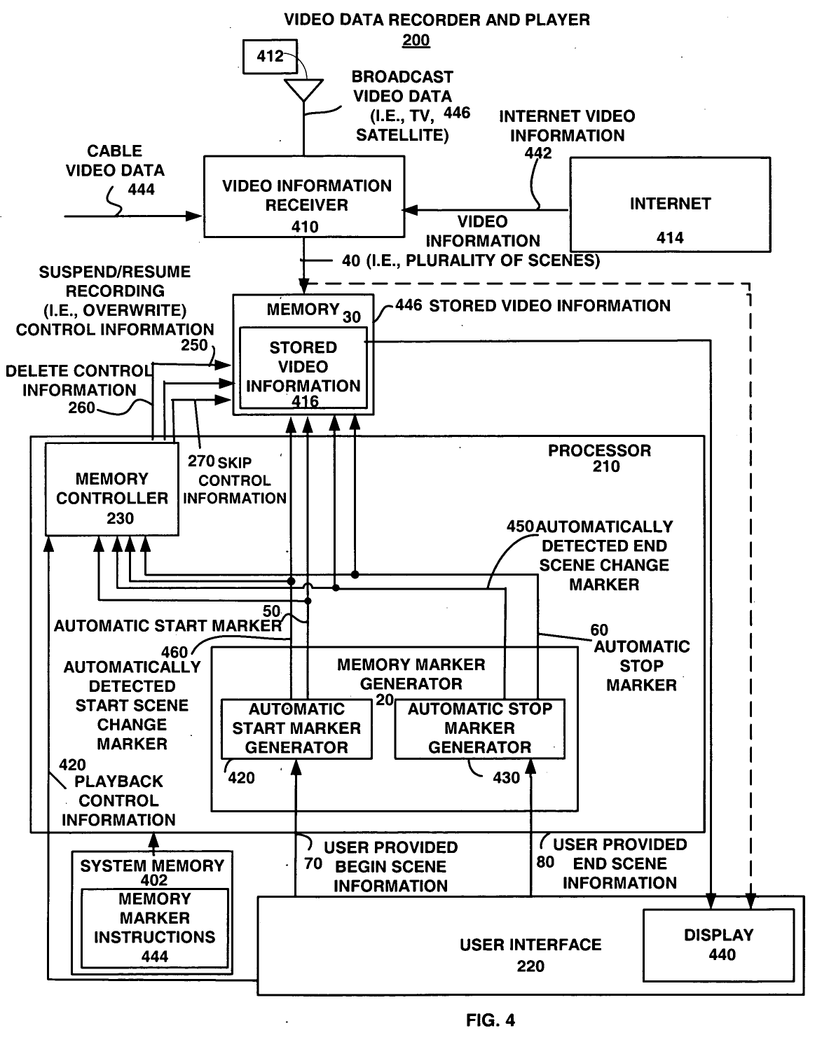

FIG. 4 is a block diagram of the video data recorder and player 200, as previously discussed with respect to FIG. 2, further including a video information receiver 410, system memory 402 including memory marker instructions, an antennae 412 and the Internet 414. The Internet 414 may provide, for example, Internet video information 442 to the video information receiver 410. Further, the video information receiver 410 may receive cable video data 444 and broadcast video data 446.

The memory 30 includes stored content information 416. The memory marker generator further includes an automatic start marker generator 420 and an automatic stop marker generator 430. The user interface 220 includes a display 440. According to one embodiment, the memory marker generator 20 searches for and detects a begin scene change or an end scene change in order to more accurately identify the desired program and the program interruption, so that the video information recorder 10, 200 may more accurately record the desired program while avoiding storage of the program interruption.

The display 440, according to one embodiment, receives the video information 40 for display to the user; for example, to assist the user in identifying a scene change during recording. During playback, the user may receive stored video information 446 from the memory 30 for display on display 440.

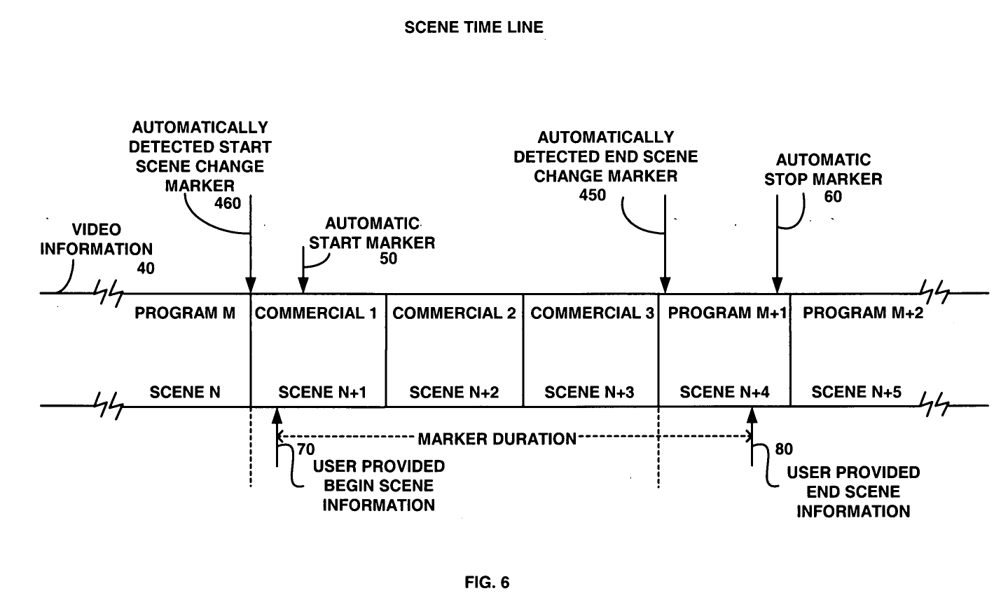

As shown in FIG. 6, the memory 30 may receive the video information, including a plurality of scenes labeled scene N, scene N+1, scene N+2, scene N+3, scene N+4, scene N+5. According to this exemplary embodiment, scene N corresponds to the end of program M. The following scene N+1 represents the first commercial, scene N+2 represents a second commercial and scene N+3 represents a third commercial. Scene N+4 represents program M+1, which may correspond with resumption of program M. As shown in this example, the user-provided begin scene information 70 is received during scene N+1, corresponding to commercial 1. As previously stated above, in response to the memory marker generator 20 receiving the user-provided end scene information 80, the memory marker generator 20 associates the automatic start marker 50 with the video information 40 stored in memory 30. Further, the memory marker generator 20 generates the automatic stop marker 60 in response to receiving the user-provided end scene information 80.

The automatic start marker generator 20 associates the automatic start marker 50 with at least one of the scenes without user intervention, in response to receiving the user-provided begin scene information 70. The automatic stop marker generator 430 detects automatically, according to one embodiment, an end scene change without user intervention from the plurality of scenes in the stored video information. The automatic stop marker generator 430 automatically associates automatically detected end scene change marker information 450 with at least one stored scene in response to detecting automatically the end scene change. The memory marker generator 20 may detect a scene change by comparing images between one or more scenes received, such as, for example, frames and an MPEG format. According to one embodiment, the memory marker generator 20 therefore includes off-the-shelf image recognition software, as is now in the art to facilitate the detection of a scene change.

According to yet another embodiment, the memory marker generator 20 may store at least one of the received plurality of scenes occurring prior to the automatic start marker 50. Accordingly, the memory marker generator 20 may automatically detect a start scene change without user intervention from the plurality of stored scenes. For example, the memory marker generator 20 may detect the start scene change between scene N and scene N+1, as shown in FIG. 6. As previously stated, memory marker generator 20 may detect a scene change by detecting a change in an image based on a change as represented in received frames of a MPEG video information.

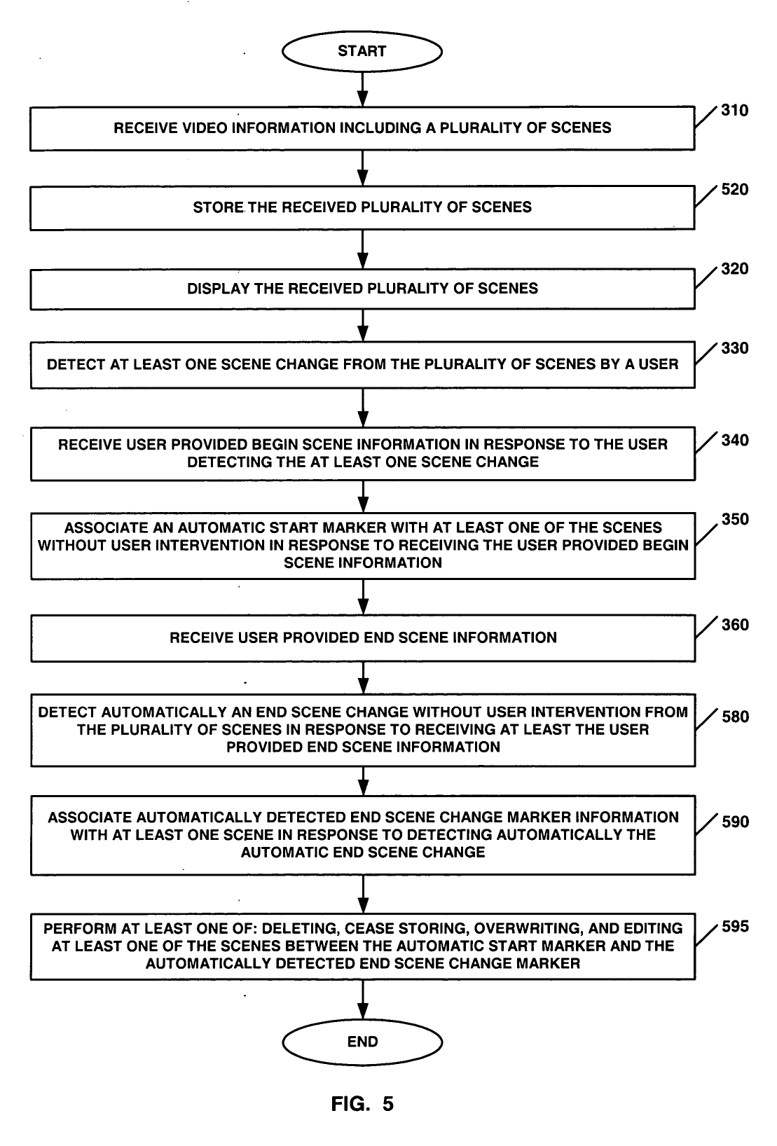

FIG. 5 illustrates a method for storing video information 40 according to another alternative embodiment. The method may be carried out by the video information recorder 10 or the video information recorder and player 200. However, any suitable structure may also be used. It will also be recognized that the method, beginning with Step 310, will be described as a series of operations; however, the operations may be performed in any suitable order and may be repeated in any suitable combination. Steps 310, 330, 340, 350 and 360 were previously described with regards to FIG. 3.

As shown in Step 520, the user interface receives the video information 40, and in response displays the video information 40 on display 440. Further, the memory 30 stores the received video information 40, including the plurality of scenes.

As shown in Steps 580 and 590, the automatic stop marker generator 430, without user intervention, automatically detects an end scene change from the plurality of scenes in response to receiving at least the user-provided end scene information 80. Further, the automatic stop marker generator 430 associates an automatically detected end scene change marker 450 with at least one stored scene, in response to detecting automatically the end scene change. For example, as shown in FIG. 6, the automatic stop marker generator 430, in response to receiving user-provided end scene information 80, searches the scenes such as scene N+4 that are in proximity with the user-provided end scene information 80. According to one embodiment, the automatic stop marker generator 430 searches the received video information 40 for a scene change. For example, the automatic stop marker generator 430 may detect the scene change between commercial 3 and scene N+3 and the resumption of program M+1 at scene N+4. As a result, the automatic stop marker generator 430 may generate the automatically detected end scene change marker 450 for association with the scene change, or alternatively, with the beginning of the resumption of program M+1, as shown in scene M+4. As a result, the automatically detected end scene change marker 450 more accurately represents the resumption of program M+1.

As show in Step 595, the memory controller 230 performs at least one of: cease storing, delete, override, and edit at least one scene between the automatic start marker and the automatically detected end scene change marker 450. For example, the memory controller 230 may control the storage of the video information 40, including the received scenes, in order to not store, delete, override or edit at least one of the scenes between the automatic start marker 50 and the automatically detected end scene change marker 450. According to one embodiment, the memory controller 230, in response to receiving both the automatic start marker 50 and the automatically detected end scene change marker 450, erases the scenes between the automatic start marker 50 and the automatically detected end scene change marker 450, in order to reduce the storage requirements for memory 30. Accordingly, the memory controller 230 will then indicate storage of the resumption of the programs such as program M+1 immediately after the automatic start marker 50, such that the memory controller 230 records over the undesired scenes such as scene N+1, N+2 and N+3, as shown in FIG. 6. According to yet another embodiment, the memory controller 230 may edit the scenes between the automatic start marker 50 and the automatically detected end scene change marker 450. Although the recording functions of the memory controller 230 were described above with reference between the automatic start marker 50 and the automatically detected end scene change marker 60, the recording functions could be formed on scenes in the stored content information 416 between the automatic start marker 50 and the automatic stop marker 60.

According to one embodiment, memory 30 stores the video information 40, including the plurality of scenes occurring prior to the automatic stop marker 60. For example, the memory controller 230 may perform a scene change detection in order to better identify the beginning of a scene change. According to one embodiment, the memory 30 stores the scenes occurring prior to the scenes associated with the automatic stop marker 60 or the automatically detected end scene change marker 450. As a result, the memory marker generator 20 may detect automatically a start scene change from the stored scenes without user intervention. As shown in FIG. 6, for example, the automatic start marker generator 420 in the memory marker generator 20 may review the video information 40 occurring prior to the automatic start marker 50 in order to better identify the actual scene change from the end of program M shown as scene N and the beginning of commercial 1 shown as scene N+1. Using, for example, off-the-shelf image recognition software, the automatic start marker generator 420 may perform, for example, a frame-by-frame analysis of the video information 40. In order to determine the scene change from scene N to scene N+1, the automatic start marker generator 420 in the memory marker generator 20 associates an automatically detected start scene change marker 460 with at least one stored scene in response to detecting the automatic start scene change. As stated previously, the automatic start marker generator 420 may include a database for associating the automatically detected start scene change marker 460 with a time stamp that may later be used to identify the time stamp associated with the video information 40, such that the time stamp will identify the particular scene associated with the new scene.

According to another embodiment, various modes of playback may be selected in using the automatic start marker 50, automatically detected start scene change marker 460, the automatic stop marker, and the automatically detected end scene change marker 450. For example, the memory controller 230 may perform at least one of display, edit displaying, and skip displaying at least one scene between the automatic start marker 50 and the automatically detected end scene change marker 450. Alternatively, the scene identified above may be between either the automatic start marker 50 or the automatically detected start scene change marker 460 and the automatic stop marker 60 and the automatically detected end scene change marker 450. For example, in response to the user interacting with the user interface 220, the user interface 220 may provide playback control information 240 to the memory controller 230 in order to control various playback functions, such as skip, fast forward and rewind. Accordingly, the user may request the display of the scenes between the automatic start marker or the automatically detected start scene change marker 460 and the automatic stop marker 60 or the automatically detected end scene change marker 450. Alternatively, the user may desire to edit or skip over these scenes.

As previously described with respect to Steps 350 and 360, the user may provide the user-provided end scene information 80 at any time. For example, the user may desire that the video information 40 is spooled into memory 30, along with automatic start markers 50 associated with scenes in response to the user-provided begin scene information 70. The user may then enter user provided end scene information 80 in order to allow the automatic stop marker generator 430 to generate either the automatic stop marker 60 or the automatically detected end scene change marker 450 for association with at least one scene in memory 30. For example, the automatic stop marker generator 430 may receive user-provided end scene information 80 in response to the user detecting at least one scene change from the plurality of scenes when the user-provided begin scene information 70 is received for the user-provided end scene information 80. Alternatively, the automatic stop marker generator 430 receives the user-provided end scene information 80 prior to the user detecting the at least one scene change from the plurality of scenes when the user-provided end scene information 80 is received for the user-provided begin scene information 70. In this case, the memory controller 230 may control the memory 30 to cease recording between either the automatic stop marker 50 in the automatically detected start scene change marker 460 and the automatic stop marker 60 in the automatically detected end scene change marker 450.

Among other advantages, the video information recorder 10 associates the automatic stop marker with at least one of the scenes or resumes recording without user intervention to assist in, for example while recording or during playback, deleting or skipping interruptions and a desired program now recording. As a result, the video information recorder 10 will automatically resume recording of the program so that if, the user becomes distracted during the program interruption and does not resume recording manually, the video information recorder will resume recording of the desired program. Further, the video information recorder 10 may be programmed to prevent storage of program interruptions, thereby decreasing the amount of storage. For example, if the user is distracted or if the user is not present during a program interruption, the video information recorder may be programmed to resume recording at a preset time without user intervention. According to one embodiment, the user-provided end scene information may be conveniently generated by the user pressing or cycling through pre-set duration increments, such as 30-second increments, specifying the anticipated duration of the program interruption. As a result, recording will resume according to the user-provided end scene information. According to another embodiment, the video information recorder may continuously record the video information. In response to associating an automatic start marker and an automatic stop marker to the stored video information, the video information recorder may automatically search for and detect a start scene change and an end scene change to more accurately identify the program interruption. According to one embodiment, once the program interruption is identified, the video information recorder may erase the program interruption in order to reduce storage waste.

It is understood that the implementation of other variations and modifications of the present invention in its various aspects will be apparent to those of ordinary skill in the art, and that the invention is not limited by the specific embodiments described. It is therefore contemplated to cover by the present invention, any and all modifications, variations or equivalents that fall within the spirit and scope of the basic underlying principles disclosed and claimed herein.

1. A method for storing video information comprising:
receiving video information including a plurality of scenes;
displaying at least the plurality of scenes;
detecting at least one scene change by a user in response to displaying the plurality of scenes;
receiving user provided begin scene information in response to the user detecting the at least one scene change;
associating an automatic start marker with at least one of the scenes without user intervention in response to receiving the user provided begin scene information;
receiving user provided end scene information;
associating an automatic stop marker with at least one of the scenes without user intervention in response to receiving at least the user provided end scene information; and
storing at least one scene subsequent to the automatic stop marker.

2. The method of claim 1 including:
storing at least one of the received plurality of scenes occurring prior to the automatic start marker;
detecting automatically a start scene change without user intervention from the plurality of stored scenes; and
associating an automatically detected start scene change marker with at least one stored scene in response to detecting the automatic start scene change.

3. The method of claim 1 including:
detecting automatically an end scene change without user intervention from the plurality of scenes, in response to receiving at least the user provided end scene information; and
associating an automatically detected end scene change marker with at least one stored scene in response to detecting automatically the end scene change.

4. The method of claim 1 wherein the end scene information includes at least one of:
a time interval relative to the automatic start marker; and
a time of day.

5. The method of claim 1 including:
storing at least one of the received plurality of scenes occurring prior to the automatic start marker; and
performing at least one of: deleting, cease storing, overwriting, and editing at least one of the scenes between the automatic start marker and the automatic stop marker.

6. The method of claim 1 including:
storing at least one of the received plurality of scenes occurring prior to the automatic start marker; and
performing at least one of: displaying, edit displaying and skip displaying at least one of the scenes between the automatic start marker and the automatic stop marker.

7. The method of claim 1 including:
receiving the user provided end scene information in response to the user detecting at least one scene change from the plurality of scenes, when the user provided begin scene information is received before the user provided end scene information; otherwise
receiving the user provided end scene information prior to the user detecting the at least one scene change from the plurality of scenes.

8. A method to store video information comprising:
receiving video information including a plurality of scenes;
storing the received plurality of scenes;
displaying the received plurality of scenes;
detecting at least one scene change from the plurality of scenes by a user;
receiving user provided begin scene information in response to the user detecting the at least one scene change;
associating an automatic start marker with at least one of the scenes without user intervention in response to receiving the user provided begin scene information;
receiving user provided end scene information;
detecting automatically an end scene change from the plurality of scenes without user intervention in response to receiving at least the user provided end scene information;
associating an automatically detected end scene change marker with at least one scene in response to detecting automatically the automatic end scene change; and
performing at least one of: deleting, cease storing, overwriting, and editing at least one of the scenes between the automatic start marker and the automatically detected end scene change marker.

9. The method of claim 8, including:
detecting automatically a start scene change without user intervention from the plurality of stored scenes; and
associating an automatically detected start scene change marker with at least one scene in response to detecting the automatic start scene change,
wherein performing at least one of: deleting, cease storing, overwriting, and editing at least one of the scenes occurs between the automatically detected start scene change marker and the automatically detected end scene change marker information.

10. The method of claim 8, wherein the end scene information includes at least one of:
a time interval relative to the automatic start marker; and
a time of day.

11. The method of claim 8, including performing at least one of: displaying, edit displaying and skip displaying the plurality of scenes between the automatic start marker and the automatically detected end scene change marker.

12. A video information recorder comprising:
a user interface operative to:
receive video information including a plurality of scenes;
display at least one of the received plurality of scenes;
receive user provided begin scene information in response to a user detecting at least one scene change from the plurality of scenes;
receive user provided end scene information;
a memory marker generator, operatively coupled to the user interface, and operative to:
associate an automatic start marker with at least one of the scenes without user intervention in response to receiving the user provided begin scene information; and
associate an automatic stop marker with at least one of the scenes without user intervention in response to receiving at least the user provided end scene information,
memory operatively coupled to the memory marker generator and to the user interface, and operable to store at least one scene subsequent to the automatic stop marker.

13. The video information recorder of claim 12, wherein the memory is operative to:
store at least one of the received plurality of scenes occurring prior to the automatic start marker;
wherein the memory marker generator is operative to:
detect automatically a start scene change without user intervention from the plurality of stored scenes; and
associate an automatically detected start scene change marker with at least one stored scene in response to detecting the automatic start scene change.

14. The video information recorder of claim 12, wherein the memory marker generator is operative to:
detect automatically an end scene change without user intervention from the plurality of scenes in response to receiving at least the user provided end scene information; and
associate an automatically detected end scene change marker with at least one stored scene in response to detecting automatically the end scene change.

15. The video information recorder of claim 12, wherein the user provided end scene information includes at least one of:
a time interval relative to the automatic start marker; and
a time of day.

16. The video information recorder of claim 12, wherein the memory is operative to store at least one of the received plurality of scenes occurring prior to the automatic start marker, the video information recorder further including:
a memory controller, operatively coupled to the memory and the memory marker generator, and operative to:
receive the automatic start marker and the automatic stop marker; and
perform at least one of: delete, cease storage, overwrite, and edit at least one of the scenes between the automatic start marker and the automatic stop marker.

17. The video information recorder of claim 12, wherein the memory is operative to store at least one of the received plurality of scenes occurring prior to the automatic start marker, the video information recorder further including:
a memory controller, operatively coupled to the memory and the memory marker generator, and operative to:
receive the automatic start marker and the automatic stop marker; and
perform at least one of: display, edit displaying and skip displaying at least one of the scenes between the automatic start marker and the automatic stop marker.

18. A video information recorder comprising:
a user interface operative to:
receive video information including a plurality of scenes;
display at least one of the received plurality of scenes;
receive user provided begin scene information in response to a user detecting at least one scene change from the plurality of scenes;
receive user provided end scene information;
memory operatively coupled to the user interface, and operable to store the received plurality of scenes;
an automatic start marker generator, operatively coupled to the user interface and to the memory, and operative to associate an automatic start marker with at least one of the scenes in response to receiving the user provided begin scene information;
an automatic stop marker generator, operatively coupled to the user interface and to the memory, and operative to detect automatically an end scene change without user intervention from the plurality of scenes and to associate an automatically detected end scene change marker with at least one stored scene in response to detecting automatically the end scene change; and
a memory controller, operatively coupled to the memory, the automatic start marker generator and the automatic stop marker generator, and operative to perform at least one of: cease storing, delete, overwrite, and edit at least one scene between the automatic start marker and the automatically detected end scene change marker.

19. The video information recorder of claim 18, wherein the automatic start marker generator is operative to:
detect an automatic start scene change without user intervention from the plurality of scenes in the stored video information; and
associate automatically detected start scene change marker information with the received video information, in response to detecting the automatic start scene change.

20. The video information recorder of claim 18, wherein the end scene information includes at least one of:
a time interval relative to the automatic start marker; and
a time of day.

21. The video information recorder of claim 18 wherein the memory controller is operative to:
perform at least one of: display, edit displaying and skip displaying at least one scene between the automatic start marker and the automatically detected end scene change marker.

22. Memory containing instructions executable by one or more processing devices that causes the one or more processing device to:
receive video information, including a plurality of scenes;
display the received video information, including the plurality of scenes;
detect at least one scene change from the plurality of scenes by a user in response to displaying the plurality of scenes;
receive user provided begin scene information in response to the user detecting the at least one scene change;
associate an automatic start marker with at least one of the scenes without user intervention in response to receiving the user provided begin scene information;
receive user provided end scene information;
associate an automatic stop marker with at least one of the scenes without user intervention in response to receiving at least the user provided end scene information; and
store at least one scene subsequent to the automatic stop marker.

23. The memory of claim 21 containing executable instructions that causes the one or more processing devices to:
store at least one of the received plurality of scenes occurring prior to the automatic start marker; and
perform at least one of: cease storing, deleting, overwriting, and editing at least one of the scenes between the automatic start marker and the automatic stop marker.

24. A method for storing video information comprising:
receiving and storing video information including a plurality of scenes;
displaying at least the plurality of scenes;
detecting at least one scene change by a user in response to displaying the plurality of scenes;
receiving user provided begin scene information in response to the user detecting the at least one scene change;
cease storing the video information in response to receiving the user provided begin scene information;
receiving user provided end scene information; and
storing, without user intervention, at least one scene subsequent to receiving the user provided end scene information.

25. The method of claim 23 including:
detecting automatically an end scene change without user intervention from the plurality of received scenes, in response to receiving at least the user provided end scene information; and
storing, without user intervention, at least one scene subsequent to detecting automatically the end scene change.
